(19) United States
(12) Patent Application Publication
(10) Pub. No.: US 2004/0078010 A1
(43) Pub. Date: Apr. 22, 2004

(54) Eye rinsing device

(76) Inventors: Tom Ahlstrom, Lidingo (SE); Hans Ehrich, Stockholm (SE); Jochen Ratjen, Stockholm (SE)

Correspondence Address: Alfred J Mangels, 4729 Cornell Road, Cincinnati, OH, 45241-2433, US

(21) Appl. No.: 10/343,905

(22) PCT Filed: Oct. 16, 2001
(86) PCT No.: PCT/SE01/02247

(30) Foreign Application Priority Data
Oct. 16, 2000 (SE) 0003730-9

(51) Int. Cl. A61H 33/04

(52) U.S. Cl. 604/301

(57) ABSTRACT

An eye rinsing device including a flask that contains an eye rinsing liquid and that is sealed by a closure element that projects up from the future opening of the flask. The flask includes an eye cup and is adapted to co-act with a flask holder. The eye cup is situated around the closure element and a sleeve surrounds the eye cup. The sleeve is non-rotatably affixed in the closure element. After the flask has been opened, by twisting the sleeve relative to the flask, the flask cannot be returned to the holder.

The present invention relates to an eye rinsing device.

A number of different eye cleansing devices which include flasks containing eye rinsing liquid for use in acute circumstances and even in other circumstances are known to the art. These flasks are often placed in a holder and removed therefrom when needed, wherewith certain flasks are opened as they are taken from the holder. Such flasks are often equipped with an eye cup into which liquid runs from the flask.

A known flask hangs vertically from a protective bar or strip, although, in this case, the eye cup is exposed to impure and contaminated air. The flask can be removed whole from the holder, in the reverse manner in which it is inserted into the holder. However, the flask is opened when removed from the holder in the manner intended.

However, it is desirable in the case of such flasks that the eye cup and its immediate surroundings are free from contaminants, so that no contaminants will enter the user's eye when using the eye rinse.

It is also desired that the flask will open automatically and be ready for use as it is taken from the holder, and that the flask can be opened with a simple hand manipulation when not located in a holder.

Thirdly, it is also desired that the flask can be returned to the holder only with difficulty; this because of possible contamination of the contents of an open flask later used to rinse the eyes of the user.

It is also desired that the flask will not be theft attractive, which is the case when an unopened flask can be removed from the holder and taken home, for instance.

Flasks constructed in accordance with known technology do not satisfy all of these desiderata at the same time.

However, the present invention relates to a flask whose eye cup is protected and which can be readily opened by withdrawing the flask from its holder and which can be readily opened outside the holder and which is difficult to put back into the holder after use, and which is not theft attractive.

The present invention thus relates to an eye rinsing device in the form of a flask that contains an eye rinsing liquid and which is sealed by a closure element that projects up from the future opening of the flask, wherein the flask further comprises an eye cup and is adapted to co-act with a flask holder, and wherein the device is characterised in that the eye cup is located around the closure element; in that the eye cup is surrounded by a sleeve; and in that the sleeve is non-rotatably attached to the closure element.

The invention will now be described in more detail with reference to an exemplifying embodiment thereof and also with reference to the accompanying drawings, in which

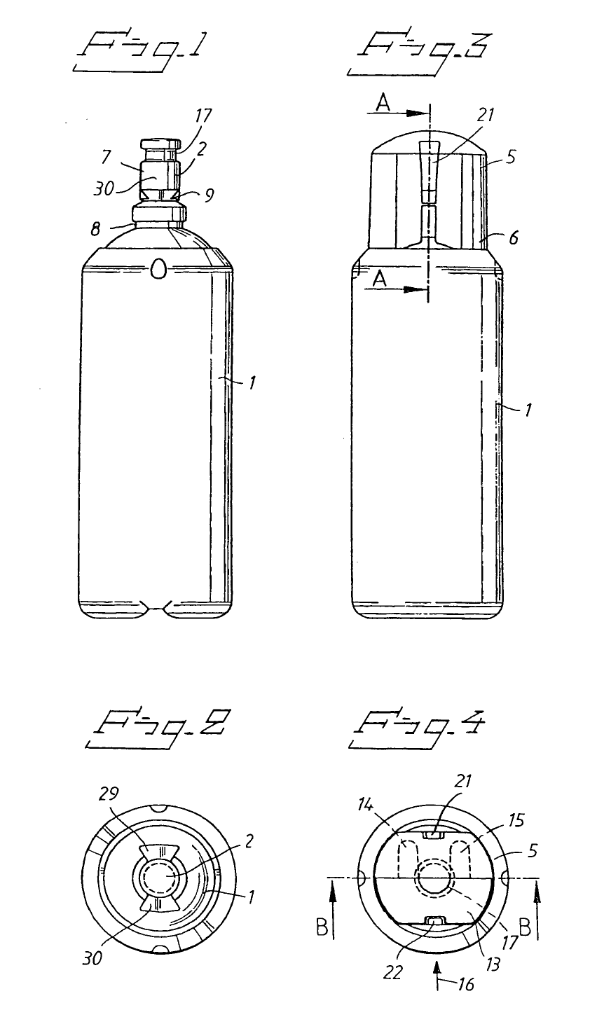

FIG. 1 is a side view of an inventive flask;

FIG. 2 is a top view of the flask shown in FIG. 1;

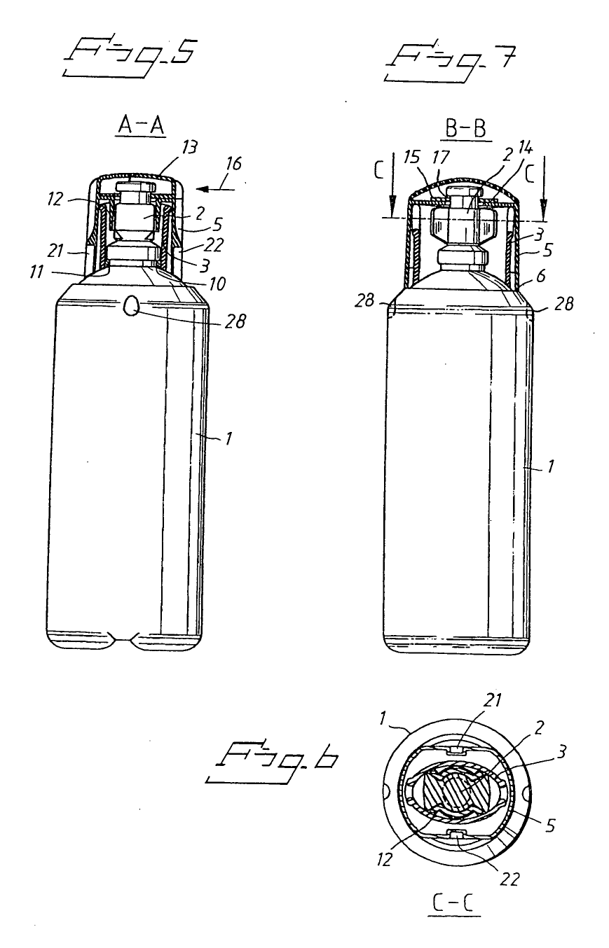

FIG. 3 is a side view of an inventive flask when provided with a sleeve;

FIG. 4 is a top view of a flask according to FIG. 3;

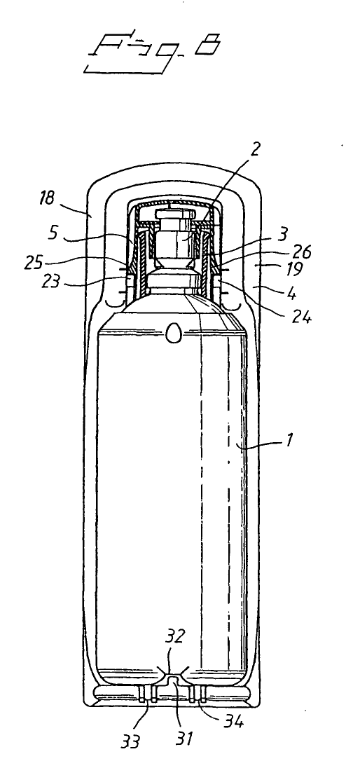

FIG. 5 is a sectioned view taken on the line A-A in FIG. 3;

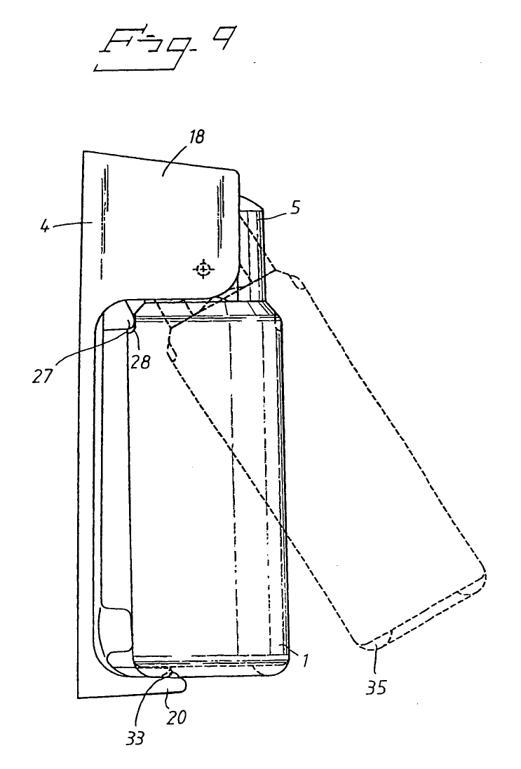

FIG. 6 is a sectioned view taken on the line C-C in FIG. 7;

FIG. 7 is a side view of an inventive flask taken on the line B-B in FIG. 4;

FIG. 8 is a side view of an inventive flask with the upper part of the flask shown in section and the flask being shown inserted in a holder;

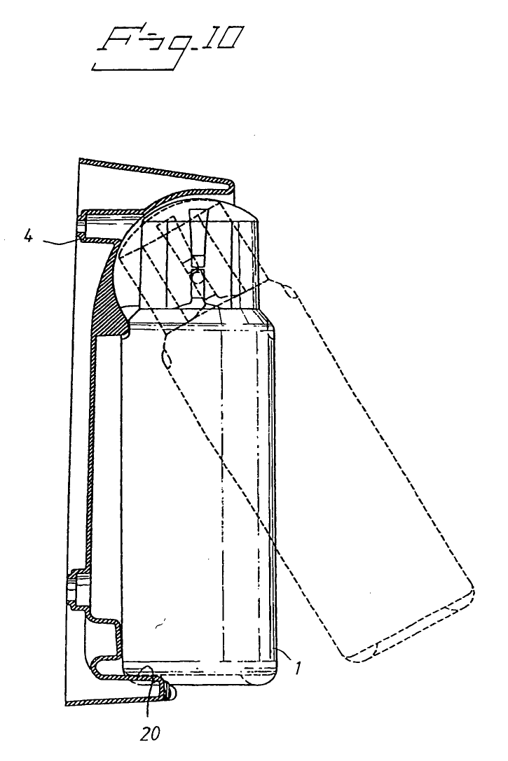

FIG. 9 illustrates an inventive flask in a holder as seen from the left in FIG. 8, and shows the flask in two different positions;

FIG. 10 is a view similar to that in FIG. 9 but with the holder cut away.

FIG. 8 shows an eye rinsing device comprising a flask I that contains an eye rinsing liquid. The flask is sealed by a closure element 2 that projects up from the future flask opening. The flask is fitted with an eye cup 3. The device includes a flask holder 4.

According to the invention, the eye cup 3 is located around the closure element 2, see FIGS. 5, 6 and 7, and can be turned around the closure element.

According to the invention, the device also includes a sleeve 5 that surrounds the eye cup 3. The lower part 6 of the sleeve 5 lies around and against the flask; see FIG. 7. This means that the eye cup will be protected by the sleeve against contamination by dust and dirt for instance. The sleeve 5 is non-rotatably fixed in the upper part 7 of the closure element 2.

According to one preferred embodiment of the invention, the closure element 2 is not axially symmetrical around the longitudinal axis of the flask. In the illustrated embodiment of the invention, the closure element includes two widening wings 29, 30. However, the closure element may have a square cross-sectional shape instead. The closure element may, of course, have another non-symmetrical form, such that the flask will be opened when the sleeve, and therewith the closure element, is/are rotated relative to the flask. The closure element 2 includes a waist 8 located beneath said future opening 9; see FIG. 1. The lower portion of the eye cup 3 engages in said waist, as evident from FIG. 5, by virtue of projections 10, 11 provided on the eye cup. The eye cup is thus snapped firmly into the waist region of the flask 1. Moreover, an inner part of the sleeve 5 engages around the non-symmetrical part 7 of the closure element 2. This will best be seen from FIGS. 5, 6 and 7, which show that the upper part of the sleeve includes an inner, downwardly projecting tubular portion 12 that engages around the axially asymmetric part of the closure element. The sleeve 5 is also affixed in the closure element 2 by means of a fastener element 13 that co-acts with said closure element. The sleeve 5 is preferably affixed in the upper part 7 of the closure element 2.

The sleeve may alternatively be affixed as an element which grips in the lower part of the closure element 2.

The provision of two widening wings 29, 30 on the closure element enables said tubular part to engage effectively with the closure element. The fastener element 13 is generally semi-circular in shape and includes two tongues 14, 15; see FIG. 4. The outer shape of the fastener element corresponds in general to the uppermost part of the sleeve. When the fastener element has been inserted to its end position in said sleeve, against the sleeve, in the direction of arrow 16 in FIGS. 4 and 5, the sleeve and the fastener element form a smooth and even unit.

The upper part 7 of the closure element 2 includes a peripherally extending recess 17. When the fastener element is inserted into the sleeves, the tongues 14, 15 will lie in abutment with the recess 17, as shown in FIGS. 4, 5 and 7. The sleeve 5 is therewith firmly seated in the flask.

The flask 1 is thus provided with an eye cup that is firmly seated in the flask, and a sleeve which is non-rotatably secured in the flask when the flask is unused.

The flask is produced in a first step in the form of the unit shown in FIG. 1. The flask is filled with an eye rinsing liquid during manufacture of the flask. The flask is then provided with the eye cup, whereafter the sleeve is fitted and fastened by means of the fastener element, said flask then having the form shown in FIG. 3.

When the flask is to be opened, the flask is rotated relative to the sleeve, therewith breaking-off the closure element at the future flask opening 9. The sleeve and the upper part of the closure element, which is firmly seated in the sleeve, are thus loosened automatically as the flask is rotated. What remains is the flask with the eye cup attached thereto. The eye cup 3 is then placed over the eye of the user and rinsing liquid flows from the flask when it is turned upside down. The rinsing liquid drains away via V-shaped channels in the short sides of the eye cup.

The inventive flask is adapted to co-act with a flask holder. The holder 4 includes two mutually spaced and outwardly directed walls 18, 19, between which the sleeve 5 can be fastened. The holder 4 also includes an outwardly directed support 20 against which the bottom of the flask 1 is intended to rest when placed in the holder.

The sleeve 5 includes two mutually opposing grooves 21, 22 that extend parallel with the longitudinal axis of the flask; see FIG. 6. The grooves 21, 22 are intended to co-act with a springy projection 23, 24 in each of the outwardly facing walls 18, 19, so as to retain the flask in the holder; see FIG. 8. Each of the grooves 21, 22 is conveniently provided with a shoulder 25, 26 intended for abutment with the springy, or resilient, projections.

This enables the flask to be readily tilted out from the holder prior to rotating the flask, as illustrated in broken lines in FIG. 9.

The intention is that it shall be possible to press a fresh flask into the holder or to push the flask into the holder from its bottom, by virtue of the projections being sprung to one side under the influence of the swung portions of the sleeve. However, when the sleeve is in place the flask cannot be removed from the holder without the flask being opened.

The projections spring back into the grooves, when the flask is in position. When the flask is placed on the supporting plane 20 of the holder, the resilient projections will be located in the vicinity of the underside of respective shoulders 25, 26.

The springy projections may be comprised of a springy plastic material. However, the projections may alternatively comprise a spring-loaded metal cylinder, in a known fashion.

After having twisted the flask and removed it from its holder, the sleeve 5 will fall down unto the floor as a result of its centre-of-gravity position having been rotated through one half of a revolution around the projections 23, 24, provided that the shoulders 25, 26 are placed sufficiently far down in the grooves 21, 22. This signifies that the sleeve is not a re-usable part of the device.

According to one preferred embodiment of the invention, the holder 4 is provided with a projection 27 (see FIG. 9) intended for co-action with a recess 28 in the parallel surface of the flask, so that the flask can only be retentively inserted into the holder when the flask is rotated to a position in which the projection engages the recess; see FIG. 9. The correct position of rotation is indicated by virtue of the fact that the sleeve is narrower in the FIG. 5 illustration than in the FIG. 7 illustration, where the distance between the outwardly facing walls 18, 19 corresponds to the narrower measurement of the sleeve. Thus, if the flask is not rotated to the aforesaid rotational position, it will not be possible to insert the bottom of the flask over said support 20.

The support 20 includes an elevated portion 31 which is intended to co-act with a corresponding groove 32 in the flask, said elevation making it at least difficult to insert a flask that has an incorrect position of rotation.

The support 20 also includes two beads 33, 34 that function to grip in the roll 35 of the flask and therewith secure the flask both laterally and longitudinally.

Although the sleeve 5 and that part of the closure element 2 which accompanies the sleeve can be placed back on the flask, it cannot be fastened at said part of the closure element that remains on the flask. Neither can the sleeve be fastened to the eye cup. This means that the sleeve may have any chosen position of rotation relative to the flask. It also means that the narrower dimension of the sleeve will give no indication as to where the recess in the flask is located. It is therefore difficult to align the recess with the projection on the holder.

This embodiment makes it difficult to return an opened flask to the holder.

The flask 1, the eye cup 3 and the sleeve 5 are comprised of an appropriate plastic material. The holder may be made of plastic, wood or metal.

It will be evident that the inventive device fulfils all of the aforesaid desiderata.

Although a number of embodiments have been described above, it will be obvious that the flask and the holder can be modified by the person skilled in this art with regard to structural elements.

The invention shall not therefore be considered restricted to the aforedescribed exemplifying embodiments thereof, as variations and modifications can be made within the scope of the accompanying claims.

1. An eye rinsing device comprising a flask (1) which contains an eye rinsing liquid and which is sealed by a closure element (2) that projects up from the future opening of said flask, wherein the flask includes an eye cup (3) and is adapted to co-act with a flask holder (4), characterised in that the eye cup (3) surrounds the closure element (2); in that a sleeve (5) surrounds the eye cup; and in that the sleeve (5) is non-rotatably affixed in the closure element (2).

2. A device according to claim 1, characterised in that the closure element (2) is non-symmetrical around the longitudinal axis of the flask (1); in that an inner part (12) of the sleeve (5) engages the axially asymmetrical part of the closure element (2); and in that the sleeve (5) is affixed in the upper part (7) of the closure element through the medium of a fastener element (13) that co-acts with said part.

3. A device according to claim 1 or 2, characterised in that the closure element (2) includes a waist (8) situated beneath said future opening (9); and in that the lower part of the eye cup (3) engages in said waist.

4. A device according to claim 1, 2 or 3, characterised in that the lower part (6) of the sleeve (5) lies around and against the flask.

5. A device according to claim 1, 2, 3 or 4, characterised in that the holder (4) includes two mutually spaced and outwardly facing walls (18, 19), between which said sleeve (5) is intended to be fastened.

6. A device according to claim 1, 2, 3, 4 or 5, characterised in that the holder (4) includes an outwardly facing support (20) against which the bottom of the flask is intended to rest.

7. A device according to claims 1, 2, 3, 4, 5 or 6, characterised in that said sleeve (5) includes two mutually opposing grooves (21, 22) located parallel with the longitudinal axis of the flask, wherein the grooves (21, 22) are intended to co-act with a springy or resilient projection (23, 249 in each of outwardly facing walls (18, 19) such as to retain the flask in the holder.

8. A device according to claim 7, characterised by shoulders (25, 26) placed in respective grooves (21, 22), wherein the shoulders are arranged to be located at and above said projections (23, 24) when the flask, together with the sleeve (5), is placed in the holder (4); and is further characterised in that the shoulders (25, 26) are positioned sufficiently far down in the grooves (21, 22) for the sleeve (5) to fall down out of the container as a result of the position of the centre-of-gravity of the sleeve having been rotated through one half of a revolution around the projections (23, 24) subsequent to twisting the flask to remove it from said holder.

9. A device according to claim 5, 6, 7 or 8, characterised in that said sleeve (5) is narrower in one direction than in a direction perpendicular thereto; and in that the distance between the outwardly facing walls (18, 19) corresponds to the narrower dimension of the sleeve.

10. A device according to any one of the preceding claims, characterised in that the holder (4) includes a projection (27) for co-action with a recess (28) in the barrel surface of the flask (1), so that the flask can only be inserted retentively in the holder (4) when the flask is rotated to a position in which the projection (27) can be inserted into the recess (28).
